(19) United States
(12) Patent Application Publication
(10) Pub. No.: US 2006/0276560 A1
(43) Pub. Date: Dec. 7, 2006

(54) Polymer precursor and method of making the same

(76) Inventors: Sivapackia Ganapathiappan, Los Altos, CA (US); Gun Young Jung, Mountain View, CA (US); Richard Stanley Williams, Portola Valley, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/146,466

(22) Filed: Jun. 7, 2005

(51) Int. Cl. H05B 6/68

(52) U.S. Cl. 522/1

(57) ABSTRACT

A polymer precursor is disclosed. The polymer precursor includes a mixture of one or more polymer(s) and one or more monomer(s). The polymer(s) is at least one of dissolved and swelled in the monomer(s).

### BACKGROUND

The present disclosure relates generally to polymer precursors and methods of making the same.

There are many processes available for forming polymeric materials into products having a desired shape or size. Processes such as injection molding or extrusion may, in some instances, use high temperatures (e.g. greater than about 100° C.) and/or high pressure (e.g. greater than about 15 psi), depending in part on the nature of the polymer to be molded or extruded. Generally, thermoplastic polymers are used in such high temperature and pressure processes so that the polymer may be relatively easily deformed. The useful life of the polymer may also be increased if a cross-linked or thermosetting polymer is used. However, molding or extruding such polymers may be expensive as the high temperature and pressure needed to soften the polymer requires a high amount of energy.

Further, current processes for forming shaped polymeric materials generally do not allow altering of the properties of the final polymeric material. This may be due, at least in part, to the lack of flexibility throughout the process for making changes to the polymer structure.

As such, it would be desirable to provide a process for forming a polymer material at lower temperatures and pressures, where the process allows for altering of the final properties of the polymeric material.

### SUMMARY

A polymer precursor is disclosed. The polymer precursor includes a mixture of one or more polymer(s) and one or more monomer(s). The polymer(s) is at least one of dissolved and swelled in the monomer(s).

### DETAILED DESCRIPTION

Embodiment(s) of the polymeric material disclosed herein are advantageously formed using a low temperature and pressure process that generally consumes less energy than current processes. Further, embodiment(s) of the process substantially reduce or eliminate material loss, as substantially all of the materials are converted during the process. Still further, properties of the formed polymeric material may advantageously be altered throughout the process. Embodiment(s) of the resultant polymeric material may advantageously be linear, cross-linked, or combinations thereof. Without being bound to any theory, it is believed that the useful life of the resultant polymeric material may be extended.

The polymeric material is formed from a polymer precursor. The polymer precursor is a mixture of one or more polymer(s)/copolymer(s) and one or more monomer(s) (i.e. a polymer-monomer mixture). The polymer precursor is formed by dissolving or swelling a selected polymer in a monomer and/or monomer mixture to form a polymer-monomer mixture. In an embodiment where a linear polymer is selected, the linear polymer is generally dissolved in the monomer. In an embodiment where a branched polymer, cross-linked polymer, or a thermosetting polymer is selected, the polymer is generally swelled in the monomer. The selected polymer may also contain polymerizable end groups.

It is to be understood that the selected polymer may be commercially available or may be formed using any suitable process, such as, for example, free radical polymerization, addition polymerization, or condensation polymerization. In an embodiment, the polymer preparation may be employed as a reaction mixture in the preparation of the polymer precursor. Further, additives, such as chain transfer agents (a non-limitative example of which includes isooctylthioglycolate), may be added to the polymer during formation. Non-limitative examples of suitable polymers include poly(benzyl methacrylate), poly(methyl methacrylate), poly(methyl acrylate), poly(butyl acrylate), poly(butyl methacrylate), poly(hexyl acrylate), poly(hexyl methacrylate), polystyrene, and combinations thereof.

As previously stated, the monomer may be a single monomer or a mixture of monomers. Non-limitative examples of suitable monomers include benzyl methacrylate, methyl methacrylate, methyl acrylate, butyl acrylate, butyl methacrylate, hexyl acrylate, hexyl methacrylate, styrene, compounds having acrylic groups, and combinations thereof.

It is to be understood that the selected polymer(s) and monomer(s) may have substantially similar chemical structures (e.g. poly(benzyl methacrylate) and benzyl methacrylate) or may have different chemical structures (e.g. poly(benzyl methacrylate) and styrene).

Further, the selected polymer(s) and/or the monomer(s) may have one predetermined property or a number of predetermined properties. It is to be understood that the property/properties may be exhibited by the formed polymeric material. As such, the selection of the polymer(s) and/or monomer(s) may alter the property/properties exhibited by the polymeric material. In a non-limitative example, a cross-linked polymer may be selected to act as a filler, thereby substantially enhancing the mechanical strength of the formed polymeric material.

In an embodiment, the predetermined property is a mechanical and/or a physical property. Non-limitative examples of mechanical properties include strength, density, elongation, modulus, or the like, or combinations thereof. Non-limitative examples of physical properties include surface smoothness, surface cracking, transparency, etching resistance, glass transition temperature, conductivity, or the like, or combinations thereof.

The polymer precursor may also include an initiator. It is to be understood that the initiator may advantageously assist in initiating polymerization of the polymer precursor. In an embodiment where polymerization of the precursor is induced by heat, the initiator may be a thermal initiator. In another embodiment where polymerization of the precursor is induced by radiation, the initiator may be a photoinitiator. In still a further embodiment, the polymer precursor may include thermal initiators and/or photoinitiators.

Further, the polymer precursor may optionally include other additives that advantageously improve desired properties. For example, additives may be used that substantially improve the cross-linking of monomers. In a non-limitative example, multifunctional monomer(s) are added to the precursor.

The polymer precursor may have any suitable physical form, depending, at least in part, on the polymer(s) and monomer(s) selected. Non-limitative examples of the physical forms of the polymer precursor include a liquid state, a gel-like state, a soft solid state, or a solid state. In an embodiment, the polymer precursor is in the form of a solution. It is to be understood that the viscosity of the polymer precursor may be adjusted by diluting the precursor with the monomer or with other viscosity modifiers.

The polymer precursor may optionally be introduced to a structure having a predetermined size, shape, geometry, configuration, and/or combinations thereof. It is to be understood that any suitable structure may be selected depending, at least in part, on the desired end use of the formed polymeric material. Non-limitative examples of the structure include sheet molds, circular molds, molds with gratings, molds with multi-level patterns, and the like. It is to be understood that the formed polymeric material may be molded into the shape, size, geometry, and/or configuration of the structure to which it is introduced.

In a non-limitative example, the structure has relatively fine openings into which the polymer precursor (generally in a free-flowing liquid form) may be filled relatively easily at low injection pressure and relatively low temperature. The viscosity of the precursor in combination with the process conditions described hereinbelow may result in a substantially defect-free and smooth polymeric material product.

The polymer precursor may be polymerized via exposure to heat and/or radiation (e.g. ultraviolet radiation, electron-beam radiation, microwave radiation, or ozone) to form the polymeric material. The polymerization and/or molding may occur in relatively low temperature and pressure conditions. In an embodiment, the relatively low temperature is less than about 100° C. In one non-limitative example, the relatively low temperature ranges from about 30° C. to about 70° C., and in another non-limitative example, the relatively low temperature ranges from about 40° C. to about 60° C. It is to be understood that radiation induced polymerization may be carried out in ambient temperature conditions.

In a further embodiment, the relatively low pressure during molding may be less than about 100 psi. In one non-limitative example, the relatively low pressure is less than about 50 psi, and in another non-limitative example, the relatively low pressure is less than about 15 psi. Without being bound to any theory, it is believed that the relatively low temperature and pressure processing advantageously allows the process to be performed with less power consumption than typical polymer forming processes.

To further illustrate embodiment(s) of the present disclosure, various examples are given herein. It is to be understood that these examples are provided for illustrative purposes and are not to be construed as limiting the scope of the disclosed embodiment(s).

### EXAMPLE 1

About 30 g of benzyl methacrylate was mixed with about 0.16 g of azobisisobutyronitrile in about 52 ml of toluene containing about 0.2 g of isooctylthioglycolate to form a solution. The solution was heated to about 75° C. for about 1 hour in a nitrogen atmosphere. After polymerization occurred, the solvent was removed under reduced pressure to isolate the poly(benzyl methacrylate).

To obtain a polymer with a narrow distribution of molecular weight, the poly(benzyl methacrylate) may be purified by being dissolved in tetrahydrofuran (THF) and precipitated in hexane. The precipitated polymer may then be isolated and dried.

About 5 g of the poly(benzyl methacrylate) was mixed with about 10 g of benzyl methacrylate to obtain a substantially clear solution. About 0.1 g of the thermal initiator azobisisobutyronitrile was added, and the solution was injected into suitable items with desirable shapes. The solution was heated to about 90° C. at a pressure of about 15 psi for about one hour to obtain the molded polymeric material having the desired shapes.

### EXAMPLE 2

About 30 g of benzyl methacrylate was mixed with about 0.16 g of azobisisobutyronitrile in about 52 ml of toluene containing about 0.2 g of isooctylthioglycolate to form a solution. The solution was heated to about 75° C. for about 1 hour in a nitrogen atmosphere. After polymerization occurred, the solvent was removed under reduced pressure to isolate the poly(benzyl methacrylate).

To obtain a polymer with a narrow distribution of molecular weight, the poly(benzyl methacrylate) may be purified by being dissolved in tetrahydrofuran (THF) and precipitated in hexane. The precipitated polymer may then be isolated and dried.

About 5 g of the poly(benzyl methacrylate) was mixed with about 10 g benzyl methacrylate to obtain a substantially clear solution. About 0.1 g of the thermal initiator azobisisobutyronitrile and about 0.5 g of the cross-linker ethylene glycol dimethacrylate was added. The solution was injected into suitable items with desirable shapes. The solution was heated to about 90° C. at a pressure of about 15 psi for about one hour to obtain the material having the desired shape.

### EXAMPLE 3

About 30 g of styrene and about 10 g of hexyl acrylate were added to about 25 ml of toluene containing about 0.15 g isooctylthioglycolate and about 0.4 g azobisisobutyronitrile to form a solution. The solution was purged with nitrogen and heated to about 100° C. for about 1 hour. The sample was cooled, and the solvent was removed. Any residual monomers were removed under reduced pressure to obtain poly(styrene-co-hexyl methacrylate).

About 2 g of poly(styrene-co-hexyl methacrylate) was dissolved in about 4 g of benzyl methacrylate. About 0.1 g of azobisisobutyronitrile was added, and the solution was injected into suitable items with desirable shapes. The solution was heated to about 90° C. at a pressure of about 15 psi for about one hour to obtain the polymeric material.

It is to be understood that the time for curing the polymer precursor may be optimized (e.g. shortened) depending, at least in part, upon the application and materials used.

Embodiments of the present disclosure offer many advantages, including, but not limited to the following. Embodiment(s) of the process substantially reduce or eliminate material loss, as substantially all of the materials are converted during the process. Further, properties (non-limitative examples of which include etching resistance, glass transition temperature, strength, modulus, and/or surface energy) of the formed polymeric material may advantageously be altered throughout the process, resulting in a polymeric material with desirable properties. Altering of the properties may advantageously be accomplished by, for example, adding additional monomer(s), chain transfer agent(s), and other materials throughout the process. The resultant polymeric material may advantageously be linear, cross-linked, or combinations thereof, and may advantageously have an extended useful life. Still further, the fabrication of the polymeric material may also advantageously be energy-effective and cost effective.

While several embodiments have been described in detail, it will be apparent to those skilled in the art that the disclosed embodiments may be modified. Therefore, the foregoing description is to be considered exemplary rather than limiting.

What is claimed is:

1. A polymeric material, comprising a polymerized polymer precursor, the polymer precursor before polymerization including at least one polymer at least one of dissolved and swelled in at least one monomer, the polymeric material exhibiting a predetermined property of at least one of the at least one polymer and the at least one monomer.

2. The polymeric material as defined in claim 1 wherein the polymer precursor further comprises an initiator.

3. The polymeric material as defined in claim 2 wherein the initiator is at least one of a thermal initiator and a photoinitiator.

4. The polymeric material as defined in claim 1 wherein the polymeric material has a predetermined shape.

5. The polymeric material as defined in claim 1 wherein the polymeric material is at least one of a linear polymeric material and a cross-linked polymeric material.

6. The polymeric material as defined in claim 1 wherein the polymer precursor further comprises a multifunctional monomer.

7. The polymeric material as defined in claim 1 wherein the predetermined property is at least one of a mechanical property and a physical property.

8. The polymeric material as defined in claim 7 wherein the mechanical property is at least one of strength, density, elongation, modulus, and combinations thereof.

9. The polymeric material as defined in claim 7 wherein the physical property is at least one of surface smoothness, surface cracking, transparency, etching resistance, glass transition temperature, conductivity, and combinations thereof.

10. The polymeric material as defined in claim 1 wherein the at least one polymer is poly(benzyl methacrylate), poly(methyl methacrylate), poly(methyl acrylate), poly(butyl acrylate), poly(butyl methacrylate), poly(hexyl acrylate), poly(hexyl methacrylate), polystyrene, and combinations thereof.

11. The polymeric material as defined in claim 1 wherein the at least one monomer is at least one of benzyl methacrylate, methyl methacrylate, methyl acrylate, butyl acrylate, butyl methacrylate, hexyl acrylate, hexyl methacrylate, styrene, compounds having acrylic groups, and combinations thereof.

12. A method of making a polymeric material, the method comprising:
at least one of dissolving and swelling at least one polymer in at least one monomer to form a polymer precursor, wherein at least one of the at least one polymer and the at least one monomer has a predetermined property;
adding an initiator to the polymer precursor; and
polymerizing the at least one monomer in the polymer precursor, thereby forming the polymeric material having the predetermined property.

13. The method as defined in claim 12, further comprising adding a multifunctional monomer to the polymer precursor prior to polymerizing the at least one monomer.

14. The method as defined in claim 12 wherein prior to polymerizing the at least one monomer, the method further comprises molding the polymer precursor.

15. The method as defined in claim 14 wherein the molding occurs at a pressure less than about 100 psi.

16. The method as defined in claim 12, further comprising forming the at least one polymer via one of free-radical polymerization, addition polymerization, and condensation polymerization.

17. The method as defined in claim 16, further comprising adding a chain transfer agent to the at least one polymer.

18. The method as defined in claim 12 wherein the initiator is a thermal initiator and wherein polymerizing is accomplished by exposing the polymer precursor to heat.

19. The method as defined in claim 12 wherein the initiator is a photoinitiator and wherein polymerizing is accomplished by exposing the polymer precursor to radiation.

20. The method as defined in claim 12 wherein the polymerizing occurs at a temperature less than about 100° C.

21. The method as defined in claim 12 wherein polymerizing is accomplished by exposing the polymer precursor to at least one of heat and radiation.

22. A polymeric material formed by the process of claim 11.

23. A polymer precursor, comprising a mixture of at least one polymer and at least one monomer, wherein the at least one polymer is at least one of dissolved and swelled in the at least one monomer.

24. The polymer precursor as defined in claim 23 wherein at least one of the at least one polymer and the at least one monomer exhibit a predetermined property.

25. The polymer precursor as defined in claim 24 wherein the mixture is capable of being polymerized to form a polymeric material exhibiting the predetermined property.

26. The polymer precursor as defined in claim 24 wherein the predetermined property is at least one of a mechanical property and a physical property.

27. The polymer precursor as defined in claim 23 wherein the mixture further comprises at least one of a thermal initiator and a photoinitiator.

28. The polymer precursor as defined in claim 23 wherein the at least one polymer is poly(benzyl methacrylate), poly(methyl methacrylate), poly(methyl acrylate), poly(butyl acrylate), poly(butyl methacrylate), poly(hexyl acrylate), poly(hexyl methacrylate), polystyrene, and combinations thereof.

29. The polymer precursor as defined in claim 23 wherein the at least one monomer is at least one of benzyl methacrylate, methyl methacrylate, methyl acrylate, butyl acrylate, butyl methacrylate, hexyl acrylate, hexyl methacrylate, styrene, compounds having acrylic groups, and combinations thereof.

30. A method of making a polymeric precursor, the method comprising at least one of dissolving and swelling at least one polymer in at least one monomer to form the polymeric precursor, at least one of the at least one polymer and the at least one monomer exhibiting a predetermined property.

31. The method as defined in claim 30, further comprising adding a multifunctional monomer to the polymeric precursor.

32. The method as defined in claim 30 wherein the polymeric precursor is capable of being polymerized to form a polymeric material exhibiting the predetermined property.

33. The method as defined in claim 30 wherein prior to at least one of dissolving and swelling, the method further comprises forming the at least one polymer via one of free-radical polymerization, addition polymerization, and condensation polymerization.

34. The method as defined in claim 33, further comprising adding a chain transfer agent to the at least one polymer.

35. The method as defined in claim 30, further comprising adding an initiator to the polymer precursor.
